(19) United States
(12) Patent Application Publication
(10) Pub. No.: US 2006/0051127 A1
(43) Pub. Date: Mar. 9, 2006

(54) Unit for screening photosensitive medium and electrophotographic image forming apparatus having the same

(75) Inventors: Il-kwon Kang, Suwon-si (KR); Se-hyun Lyu, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,627

(22) Filed: Jun. 3, 2005

(30) Foreign Application Priority Data
Sep. 6, 2004 (KR) 10-2004-0070794

(51) Int. Cl. G03G 21/18

(52) U.S. Cl. 399/114

(57) ABSTRACT

A unit is provided to screen a photosensitive medium and an electrophotographic image forming apparatus having the same. The unit for screening a photosensitive medium includes a shutter elastically biased in a direction in which the photosensitive medium is screened. A first link, which is capable of making a straight reciprocating motion in a first direction and has a pusher pressing and pushing the shutter to expose the photosensitive medium. A second link, which is connected to the first link and is capable of making a straight reciprocating motion in a second direction not parallel to the first direction. When a door of the electrophotographic image forming apparatus is closed, the second link moves so that the first link moves in a direction in which the photosensitive medium is exposed.

### CROSS REFERENCE TO RELATED APPLICATION

This application claims the benefit under 35 U.S.C. § 119(a) of Korean Patent Application No. 10-2004-0070794, filed on Sep. 6, 2004, in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to a unit for screening a photosensitive medium to prevent exposure and light fatigue of the photosensitive medium and an electrophotographic image forming apparatus having the same.

2. Description of the Related Art

Generally, an electrophotographic image forming apparatus, such as a laser printer or a digital copying machine, is a device in which an electrostatic latent image is formed on an outer circumference of a photosensitive medium charged to a predetermined electric potential by scanning light onto the photosensitive medium. Toner, which is a developing agent, is injected into the electrostatic latent image and is developed as a visible image. The image is then transferred onto paper and fused on the paper so that an image is printed. Light fatigue of the photosensitive medium, wherein sensitivity with respect to light is reduced, occurs when the photosensitive medium is used for a long time. When a clear image cannot be printed any more, the photosensitive medium is replaced with a new one. When the photosensitive medium is exposed to external light for a long time, light fatigue occurs quickly. Thus, the electrophotographic image forming apparatus generally includes a unit for screening the photosensitive medium to maximize the life of the photosensitive medium.

FIGS. 1 and 2 respectively illustrate an example of a conventional unit for screening a photosensitive medium. That is, FIG. 1 illustrates opened shutters for the photosensitive medium. FIG. 2 illustrates closed shutters for the photosensitive medium.

Referring to FIGS. 1 and 2, the conventional unit for screening a photosensitive medium includes four shutters 10 that are elastically biased in a direction in which each photosensitive medium 1 is screened. A link 15 has four pushers 16 that push each of the shutters 10 to expose each photosensitive medium 1. First and second gears 20 and 26 connect a door 30 of an image forming apparatus to the link 15, a cam 22, and a pair of springs 24 and 28. The image forming apparatus is a device that prints a color image and includes four photosensitive media on which an image having a single color such as cyan (C), magenta (M), yellow (Y), or black (K) is formed. Although not shown, each of the four photosensitive media 1 is mounted in one of the developing units that respectively stores a toner having a color, such as cyan (C), magenta (M), yellow (Y), and black (K). Each of the four shutters 10 screens onephotosensitive medium 1 and is disposed in one of the developing units. Additionally, the four pushers 16 that push the four shutters 10 are placed in a lengthwise direction of the link 15.

As shown in FIG. 1, when the door 30 of the image forming apparatus is closed, the pushers 16 that protrude from the link 15 push each lever 11 of each shutter 10 in an upward direction so that each shutter 10 does not screen each photosensitive medium 1. However, when the door 30 is opened, a protrusion 32 of the door 30 rotates the second gear 26, which in turn rotates the first gear 20 engaged with the second gear 26. The cam 22 coupled with the first gear 20 is rotated with the first gear, thereby causing the link 15 to descend. As such, each pusher 16 does not press each lever 11 of each shutter 10 any more and each shutter 10 moves by an elastic restoration force to screen each photosensitive medium 1 from external light in a direction indicated by the arrow, as shown in FIG. 2. If the door 30 is closed again, due to a tension force generated by the springs 24 and 28, the first and second gears 20 and 26 and the cam 22 return to their original positions, as shown in FIG. 1. Thus, the link 15 ascends again and each pusher 16 pushes each lever 11 of each shutter 10 so that each shutter 10 does not screen each photosensitive medium 1.

However, in the above-described conventional unit for screening the photosensitive medium many parts are needed, thereby making assembly of the unit difficult and the operation of the parts complicated. Thus, the cost of the conventional unit is high and the operational reliability thereof is lowered. Additionally, it is difficult to use the conventional unit for screening the photosensitive medium in a small-sized electrophotographic image forming apparatus.

Accordingly, a need exists for an improved unit to screen photosensitive medium of an electrophotographic image forming apparatus that has fewer parts, thereby reducing associated costs and increasing the reliability and efficiency of the apparatus.

### SUMMARY OF THE INVENTION

The present invention provides a unit for screening a photosensitive medium having a reduced number of parts, and an electrophotographic image forming apparatus having the unit.

The present invention also provides a unit for screening a photosensitive medium having a simple structure and an improved operational reliability, and an electrophotographic image forming apparatus having the same.

According to an aspect of the present invention, a unit for screening a photosensitive medium in an electrophotographic image forming apparatus includes a shutter elastically biased in a direction in which the photosensitive medium is screened. A first link, which is capable of making a straight reciprocating motion in a first direction, has a pusher pressing and pushing the shutter to expose the photosensitive medium. A second link, which is connected to the first link, makes a straight reciprocating motion in a second direction not parallel to the first direction. When a door of the electrophotographic image forming apparatus is closed, the second link moves so that the first link moves in a direction in which the photosensitive medium is exposed.

The second link may include a guide groove extending in the direction not parallel to the first direction. The first link may include a guide protrusion placed in the guide groove. When the second link moves in the second direction, the guide protrusion may slide in the guide groove and moves the first link in the first direction.

The first direction may be a vertical line, the second direction may be a horizontal line, and the guide groove may extend in a third direction along an oblique line.

A plurality of photosensitive media and a plurality of shutters screening the plurality of photosensitive media may be placed along a direction in which the first link extends. The first link may include a plurality of pushers pressing and pushing the plurality of shutters.

The second link may be elastically supported by a spring so that the second link returns to its original position when the door is closed and opened again.

According to another aspect of the present invention, an electrophotographic image forming apparatus includes a case having a door, and a photosensitive medium that is inserted and mounted inside the case by opening the door. A unit screens the photosensitive medium when the door is opened. The unit for screening a photosensitive medium includes a shutter elastically biased in a direction in which the photosensitive medium is screened. A first link, which is capable of making a straight reciprocating motion in a first direction, has a pusher pressing and pushing the shutter to expose the photosensitive medium. A second link, which is connected to the first link, makes a straight reciprocating motion in a second direction not parallel to the first direction. When the door is closed, the second link moves so that the first link moves in a direction in which the photosensitive medium is exposed.

The second link may include a guide groove extending in the direction not parallel to the first direction. The first link may include a guide protrusion placed in the guide groove. When the second link moves in the second direction, the guide protrusion may slide in the guide groove and moves the first link in the first direction.

The first direction may be a vertical line, the second direction may be a horizontal line, and the guide groove may extend in a third direction along an oblique line.

A plurality of photosensitive media and a plurality of shutters screening the plurality of photosensitive media may be placed along a direction in which the first link extends. The first link may include a plurality of pushers pressing and pushing the plurality of shutters.

The second link may be elastically supported by a spring so that the second link returns to its original position after the door is opened again.

Other objects, advantages and salient features of the invention will become apparent from the following detailed description, which taken in conjunction with the annexed drawings, discloses preferred embodiments of the invention.

### BRIEF DESCRIPTION OF THE DRAWINGS

The above aspects and advantages of the present invention will become more apparent by describing in detail exemplary embodiments thereof with reference to the attached drawings, in which:

FIGS. 1 and 2 illustrate an example of a conventional unit for screening a photosensitive medium;

FIG. 3 is an elevational view in partial cross section of an electrophotographic image forming apparatus according to an exemplary embodiment of the present invention;

FIG. 4 is an elevational view of a developing unit of FIG. 3;

FIGS. 5 and 6 are elevational views of a unit for screening a photosensitive medium according to exemplary embodiments of the present invention; and

FIG. 7 is an elevational view in cross section taken along line VII-VII of FIG. 6 of a guide protrusion of a first link received by a guide groove.

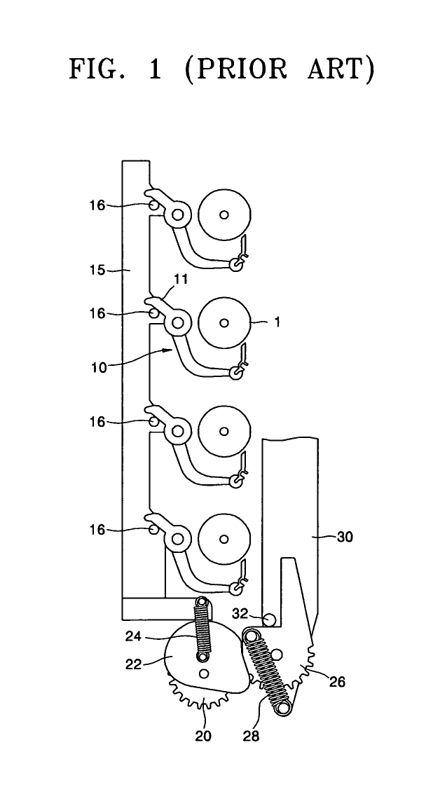

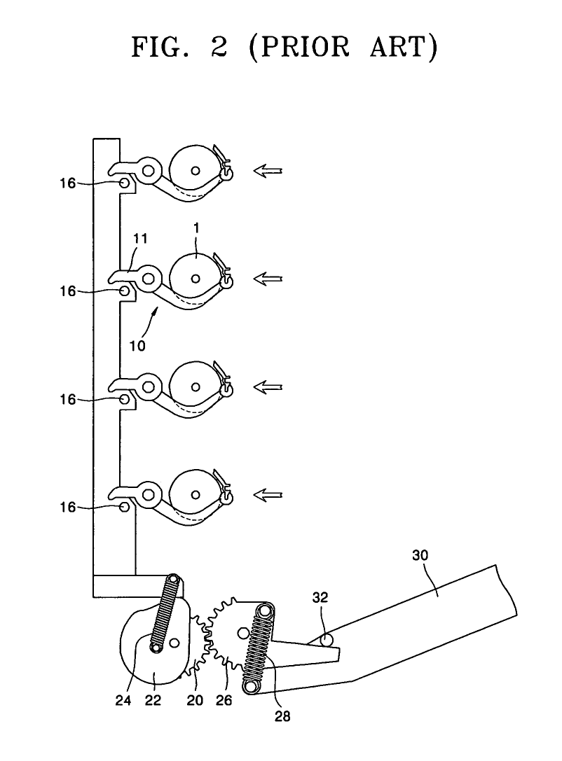

Throughout the drawings, like reference numerals will be understood to refer to like parts, components and structures.

### DETAILED DESCRIPTION OF EXEMPLARY EMBODIMENTS

Exemplary embodiments of the present invention will be described with reference to the accompanying drawings.

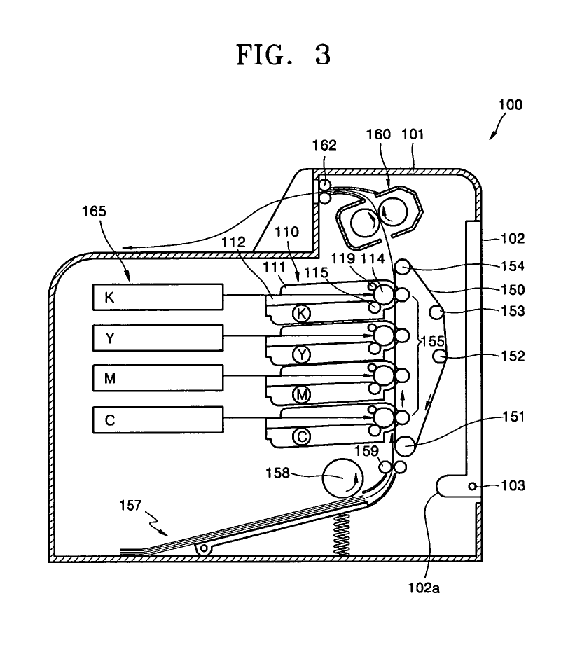

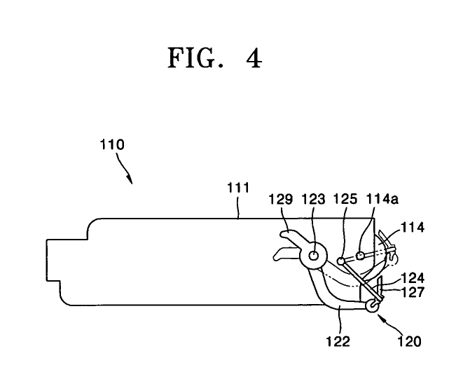

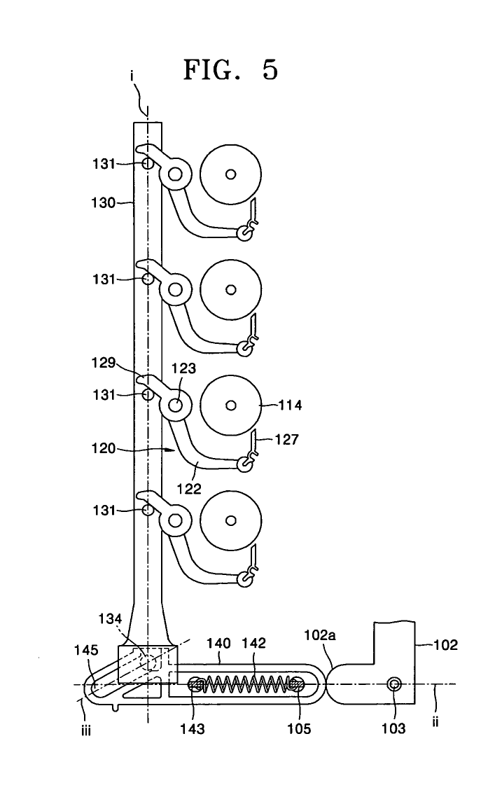

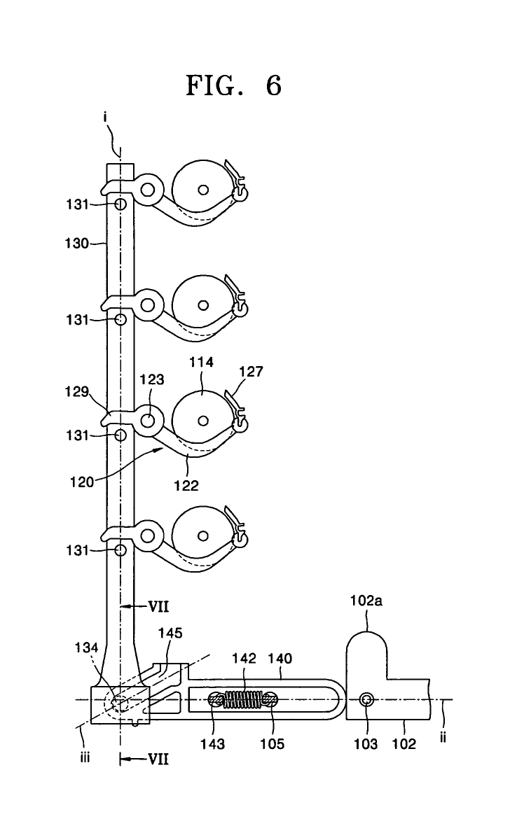

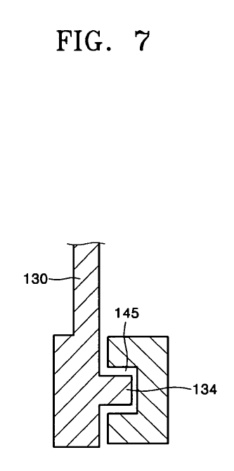

FIG. 3 is an elevational view in partial cross section of an electrophotographic image forming apparatus according to an exemplary embodiment of the present invention. FIG. 4 is an elevational view of a developing unit shown of FIG. 3. FIGS. 5 and 6 are elevational views of a unit for screening a photosensitive medium according to exemplary embodiments of the present invention. FIG. 5 is an elevational view of a photosensitive medium in which the shutters are opened. FIG. 6 is an elevational view of a photosensitive medium in which the shutters are closed. FIG. 7 is an elevational view in cross section taken along line VII-VII of FIG. 6 of a guide protrusion of a first link received by a guide groove.

Referring to FIG. 3, an electrophotographic image forming apparatus 100 according to an exemplary embodiment of the present invention includes four developing units 110 placed inside a case 101, four light scanning units (LSUs) 165, a carrier belt 150, four transfer rollers 155, and a fusing unit 160. The electrophotographic image forming apparatus 100 further includes a cassette 157 on which paper is stacked, a pickup roller 158 that picks up a sheet of paper from the cassette 157, a feed roller 159 which feeds the picked-up paper, and a paper exiting roller 162 which discharges the paper on which an image is printed outside the case 101.

The four developing units 110 are replaced with new ones when toner, which is used as a developing agent, is exhausted. In the exemplary embodiment shown in FIG. 3, to print color images, the four developing units 110 include four developing units 110C, 110M, 110Y, and 110K, each of which respectively store a toner having a color such as cyan (C), magenta (M), yellow (Y), and black (K). When a door 102 placed on a side of the case 101 is opened, the carrier belt 150 and rollers 151 to 155 supporting the carrier belt 150 are arranged in a widthwise direction so that the developing units 110C, 110M, 110Y, and 110K in which a toner is exhausted may be replaced with new ones.

The carrier belt 150 is supported by a plurality of support rollers 151 to 154 and circulates in a vertical direction. In an exemplary embodiment, four LSUs 165C, 165M, 165Y, and 165K are installed to correspond to the four developing units 110C, 110M, 110Y, and 110K. Each of the LSUs 165C, 165M, 165Y, and 165K scans a beam corresponding to image information about cyan (C), magenta (M), yellow (Y), and black (K) colors onto each photosensitive drum 114 that is a photosensitive medium mounted in each housing 111 of each of the developing units 110C, 110M, 110Y, and 110K. The LSUs 165C, 165M, 165Y, and 165K may be laser scanning units that use a laser diode as a light source.

Each of the developing units 110C, 110M, 110Y, and 110K has a photosensitive drum 114 disposed inside each housing 111 and a developing roller 115. To transfer an image onto a piece of paper, a portion of an outer circumference of each photosensitive drum 114 that faces the carrier belt 150 is exposed to an outside of each housing 111 when the image is printed. Additionally, each of the developing units 110C, 110M, 110Y, and 110K has a charging roller 119. A charging bias voltage is applied to each charging roller 119 so that an outer circumference of the photosensitive drum 114 is charged to a uniform electric potential. A corona discharger (not shown) instead of the charging roller 119 may be used. Each developing roller 115 supplies toner to the photosensitive drum 114 by adhering the toner to the outer circumference of the photosensitive drum 114. A development bias voltage is applied to each developing roller 115 to supply toner to the photosensitive drum 114. Additionally, although not shown, a supplying roller that supplies toner to each developing roller 115, a doctor blade that regulates the amount of toner adhered to each developing roller 115, and a conveyor-shaped agitator that transfers toner held in each housing 111 to the supplying roller are further provided inside the housing 111 of each of the developing units 110C, 110M, 110Y, and 110K. Each of the developing units 110C, 110M, 110Y, and 110K in an exemplary embodiment includes an opening 112 that forms a path so that the beam scanned by the LSUs 165C, 165M, 165Y, and 165K is irradiated onto the photosensitive drum 114.

Each of the four transfer rollers 155 is disposed to face each photosensitive drum 114 of each of the developing units 110C, 110M, 110Y, and 110K when the carrier belt 150 is placed between each transfer roller 155 and each photosensitive drum 114. A transfer bias voltage is applied to the transfer roller 155.

The operation of forming a color image using the electrophotographic image forming apparatus having the above structure is described below.

Each photosensitive drum 114 of each of the developing units 110C, 110M, 110Y, and 110K is charged to a uniform electric potential by the charging bias voltage applied to the charging roller 120. Each of the LSUs 165C, 165M, 165Y, and 165K scans a beam corresponding to image information about cyan (C), magenta (M), yellow (Y), and black (K) colors onto each photosensitive drum 114 of each of the developing units 110C, 110M, 110Y, and 110K through the opening 112 so that an electrostatic latent image is formed on the outer circumference of the photosensitive drum 114. A development bias voltage is applied to the developing roller 115. Then, the toner moves from the developing roller 115 onto the outer circumference of the photosensitive drum 114 so that visible images having colors, such as cyan (C), magenta (M), yellow (Y), and black (K), are formed on the outer circumference of the photosensitive drum 114 of each of the developing units 110C, 110M, 110Y, and 110K.

The paper is picked up by the pickup roller 158 from the cassette 157 and inserted into the carrier belt 150 by the feed roller 159. The paper is attached to the surface of the carrier belt 150 by an electrostatic force and fed at the same velocity as a traveling linear velocity of the carrier belt 150.

When a front end of a visible image of cyan (C) color formed on the outer circumference of the photosensitive drum 114 of the developing unit 110C disposed in the lowermost position reaches a transfer nip that faces the transfer roller 155, a front end of the paper attached to the carrier belt 150 reaches the transfer nip. In this case, if a transfer bias voltage is applied to the transfer roller 155, the visible image formed on the photosensitive drum 114 is transferred onto the paper. As the paper is transferred continuously, visible images of colors such as magenta (M), yellow (Y), and black (K) formed on the outer circumference of each photosensitive drum 114 of the other developing units 110M, 110Y, and 110K overlap with one another sequentially and are transferred onto the paper so that visible color images are formed on the paper. The fusing unit 160 fuses the visible color images on the paper by applying heat and pressure to the visible color images. The paper on which the visible color images are fused is discharged outside the case 101 by the paper exiting roller 162.

The electrophotographic image forming apparatus 100 further includes a unit for screening a photosensitive medium to substantially prevent the photosensitive medium 114 from being exposed to external light when the door 102 is opened. Referring to FIGS. 5 and 6, the unit for screening the photosensitive medium includes a shutter 120 and first and second links 130 and 140 that make a reciprocating motion in a direction in which the first and second links 130 and 140 cross with each other.

Referring to FIG. 4, the shutter 120 is rotatably mounted in the housing 111 of the developing unit 110 and has a screen 127 for screening the photosensitive drum 114. The screen 127 is hingedly coupled with each end of a first arm 122 mounted on a side of the housing 111 to be rotated around a first hinge shaft 123. Each end of a second arm 124 is rotatably mounted to a second hinge shaft 125. The first and second hinge shafts 123 and 125 do not coincide with a rotational center 114a of the photosensitive drum 114. The rotational radius of the first arm 122 is preferably larger than that of the second arm 124. Thus, the screen 127 may be close to the photosensitive drum 114 along an outer circumference contour line of the photosensitive drum 114 when the screen 127 screens the photosensitive drum 114, as indicated by a double-dashed line, and light may be effectively prevented from being streamed on the photosensitive drum. Additionally, damage, such as scratching the photosensitive drum 114 caused by the screen 127, is substantially prevented even when the screen 127 descends so that the photosensitive drum 114 is exposed.

Although not shown, a torsion spring is disposed in the vicinity of the first hinge shaft 123 to elastically bias the first arm 122 to rotate counterclockwise, that is, in a direction in which the screen 127 screens the photosensitive drum 114. Additionally, a lever 129 is disposed in the vicinity of the first hinge shaft 123. The lever 129 extends in a direction substantially opposite to the first arm 122 from the first hinge shaft 123. Thus, if the lever 129 is pressed and pulled in an upward direction, the first arm 122 and the screen 127 coupled with the first arm 122 descend and the photosensitive drum 114 is exposed.

For an easy understanding of the unit for screening the photosensitive medium, the housing 111 of the developing unit 110 and the second arm 124 of the shutter 120 are not shown in FIGS. 5 and 6. Referring to FIGS. 5 and 6, the first link 130 is a bar-shaped member that extends in a first direction i, a substantially vertical line, and is mounted inside a case (see 101 of FIG. 3) to make a substantially straight reciprocating motion. Four pushers 131, which push each lever 129 of the shutters 120 arranged in a vertical direction together with the photosensitive drum 114, are arranged in the first link 130 in a line. Each of the four pushers 131 protrudes from a side of the first link 130 in a substantially horizontal direction and is disposed under each of the levers 129. A guide protrusion 134 is placed in a bottom end of the first link 130.

A second link 140 is a bar-shaped member that extends in a second direction ii, a substantially horizontal line, and is mounted inside the case (see 101 of FIG. 3) to make a straight reciprocating motion. A guide groove 145 extends in a third direction iii, an oblique line, is disposed in one end of the second link 140. As shown in FIG. 7, a guide protrusion 134 of the first link 130 is held in the guide groove 145. Thus, a straight reciprocating motion in the second direction ii of the second link 140 is changed into a straight reciprocating motion in the first direction i of the first link 130. When the door 102 is rotated around its hinge shaft 103 and closed, the other end of the second link 140 contacts a protrusion 102a formed in the vicinity of the hinge shaft 103 and is moved to the left side.

A spring 142 is inserted in the second link 140. One end of the spring 142 is engaged with an engagement protrusion 143 fixedly connected to the second link 140, and the other end of the spring 142 is engaged with an engagement protrusion 105 fixedly connected to an inside of the case 101. The spring 142 is preferably a tension spring. In FIG. 6, the spring 142 is shown in a neutral state. In FIG. 5, the spring 142 is in an extended state.

The operation of the unit for screening the photosensitive medium is described below with reference to FIGS. 5 and 6.

When the door 102 of the image forming apparatus (see 100 of FIG. 3) is opened, as shown in FIG. 6, the tension spring 142 does not extend, the guide protrusion 134 is held in a bottom end of the guide groove 145, and the first link 130 descends. Thus, the lever 129 of the shutter 120 is not pushed by the pusher 131 and the screen 127 of the shutter 120, which is elastically biased in a direction in which the photosensitive drum 114 is screened, ascends so that the photosensitive drum 114 is prevented from being exposed to external light.

When the door 102 is closed, as shown in FIG. 5, the second link 140 is pushed by the protrusion 102a of the door 102 and the guide protrusion 134 is pushed on a slanted surface of the guide groove 145 and ascends. As such, the pusher 131 of the first link 130 ascends and pushes the lever 129. The screen 127 descends, and the photosensitive drum 114 is exposed. the image forming apparatus is now in a state where a printing operation may be performed. When the door 102 is opened again, the second link 140 moves to the right by a restoration force generated by the tension spring 142, as shown in FIG. 6, and the guide protrusion 134 is pushed on a slanted surface of the guide groove 145 and descends again. Thus, the pusher 131 of the first link 130 descends again, the screen 127 ascends, and the photosensitive drum 114 is prevented from being exposed.

As described above, the unit for screening the photosensitive medium according to exemplary embodiments of the invention has a reduced number of parts and a simple structure, and an operational reliability thereof is improved. Additionally, the size of the unit for screening the photosensitive medium is reduced.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A unit for screening a photosensitive medium in an electrophotographic image forming apparatus, comprising:
a shutter elastically biased in a direction in which the photosensitive medium is screened;
a first linkreciprocally movable in a first direction, and a pusher connected to the first link to press and push the shutter to expose the photosensitive medium;
a second link connected to the first link and reciprocally movable in a second direction, and
a door connected to the electrophotographic image forming apparatus such that when the door is closed the second link moves to move the first link to expose the photosensitive medium.

2. The unit of claim 1, wherein
the first direction is not parallel to the second direction.

3. The unit of claim 1, wherein
a guide groove in the second link extends in a third direction; and
a guide protrusion in the first link is disposed in the guide groove, such that when the second link moves in the second direction, the guide protrusion slides in the guide groove to move the first link moves in the first direction.

4. The unit of claim 3, wherein
the third direction is not parallel to the first direction.

5. The unit of claim 3, wherein
the first direction is a substantially vertical line, the second direction is a substantially horizontal line, and the guide groove extends in the third direction along an oblique line.

6. The unit of claim 1, wherein
a plurality of photosensitive media and a plurality of shutters screening the plurality of photosensitive media are placed along a direction in which the first link extends, and
a plurality of pushers connected to the first link press and push the plurality of shutters.

7. The unit of claim 1, wherein
a spring is connected to the second link to returnit's the second link to an original position when the door is opened.

8. An electrophotographic image forming apparatus, comprising
a case having a door;
a photosensitive medium that is inserted and mounted inside the case by opening the door;
a unit to screen the photosensitive medium when the door is opened;
a shutter elastically biased in a direction in which the photosensitive medium is screened;
a first link reciprocally movable in a first direction;
a pusher connected to the first link to press and push the shutter to expose the photosensitive medium; and
a second link connected to the first link and reciprocally movable in a second direction, such that when the door is closed, the second link moves to move the first link to expose the photosensitive medium.

9. The unit of claim 1, wherein
the first direction is not parallel to the second direction.

10. The apparatus of claim 8, wherein
a guide groove in the second link extends in a third direction; and
a guide protrusion in the first link is disposed in the guide groove, such that when the second link moves in the second direction the guide protrusion slides in the guide groove and moves the first link in the first direction.

11. The apparatus of claim 10, wherein
the first direction is a substantially vertical line, the second direction is a substantially horizontal line, and the guide groove extends in the third direction along an oblique line.

12. The apparatus of claim 8, wherein
a plurality of photosensitive media and a plurality of shutters screening the plurality of photosensitive media are placed along a direction in which the first link extends, and
a plurality of pushers connected to the first link to press and push the plurality of shutters.

13. The apparatus of claim 8, wherein
the second link is elastically supported by a spring so that the second link returns to its original position when the door is opened.

14. An electrophotographic image forming apparatus, comprising
a case having a door;
a plurality of photosensitive media disposable in and removable from the case through the door;
a unit for each of the plurality of photosensitive media to screen the plurality of photosensitive media when the door is opened;
a shutter for each of the plurality of photosensitive media elastically biased to screen the plurality of photosensitive media;
a first link reciprocally movable in a first direction;
a pusher for each shutter connected to the first link to press and push the shutter to expose the plurality of photosensitive media; and
a second link connected to the first link and reciprocally movable in a second direction not parallel to the first direction, such that when the door is closed, the second link moves to move the first link to expose the plurality of photosensitive media.

15. The apparatus of claim 14, wherein
a guide groove in the second link extends in a third direction; and
a guide protrusion in the first link is disposed in the guide groove, such that when the second link moves in the second direction the guide protrusion slides in the guide groove and moves the first link in the first direction.

16. The apparatus of claim 15, wherein
the first direction is a substantially vertical line, the second direction is a substantially horizontal line, and the guide groove extends in the third direction along an oblique line.

17. The apparatus of claim 14, wherein
a spring elastically biases the second link so that the second link returns to its original position when the door is opened.

18. The apparatus of claim 17, wherein
a first end of the spring is connected to the second link and a second end of the spring is connected to the case.
